(19) United States
(12) Patent Application Publication
(10) Pub. No.: US 2014/0025788 A1
(43) Pub. Date: Jan. 23, 2014

(54) METRICS FOR NETWORK CONFIGURATION ITEMS

(71) Applicants: Ramakrishnan Krishna MAHADEVAN, Bangalore (IN); Pargaonkar VISHWANATH, Bangalore (IN)

(72) Inventors: Ramakrishnan Krishna MAHADEVAN, Bangalore (IN); Pargaonkar VISHWANATH, Bangalore (IN)

(21) Appl. No.: 13/551,735

(22) Filed: Jul. 18, 2012

(51) Int. Cl. G06F 15/177

(52) U.S. Cl. 709/220

(57) ABSTRACT

A system may include a discovery engine to perform a discovery process on a network of multiple configuration items and to populate a data structure with information about each discovered configuration item in the network. The information may include a configuration parameter for each configuration item and a metric to be monitored for the configuration item.

### BACKGROUND

Networks, such as those provided in datacenters, include various configuration items. Configuration items may include hardware (e.g., servers, processors, routers, switches, etc.) and/or software (e.g., an operation system) that is configurable in some way. Configuration items may be used to implement, for example, a network in a datacenter.

### BRIEF DESCRIPTION OF THE DRAWINGS

For a detailed description of various examples, reference will now be made to the accompanying drawings in which:

FIG. 1 shows a system in accordance with an example;

FIG. 2 also shows a system in accordance with an example;

FIG. 3 shows an example of contents of a configuration management database;

FIG. 4 shows a system implementation in accordance with an example;

FIG. 5 illustrates an architectural overview in accordance with various examples; and

FIG. 6 show a method in accordance with various examples.

### DETAILED DESCRIPTION

As noted above, a network includes various configuration items coupled together. A datacenter, for example, includes numerous configuration items. Users may desire to monitor such configuration items for a variety of reasons. For example, failures of configuration items need to be identified and resolved. By way of another example, a user may want to monitor processor utilization. If processor utilization greater than a threshold may be symptomatic of the network being overloaded with traffic and that additional processor resources may need to be brought on-line.

Various analysis tools may be available to monitor a network, but such tools are generally static and only monitor certain aspects of a network for which they are pre-programmed. Further, certain metrics may be collected by collection logic but again the metrics that the collection logic obtains are pre-programmed into the collection logic. Thus, the collection of network metrics and the usage of such metric data is statically “hard-wired” into the collection and analysis tools that may be available.

In accordance with various implementations, a system can be readily configured to monitor any type of metrics and analysis tools are provided that can be configured as desired to use such metrics. Thus, rather than having the metrics hard-wired into the collection and analysis tools, such tools consult a configurable database for the metrics that are available for their use, and metrics that populate the database are themselves readily configurable.

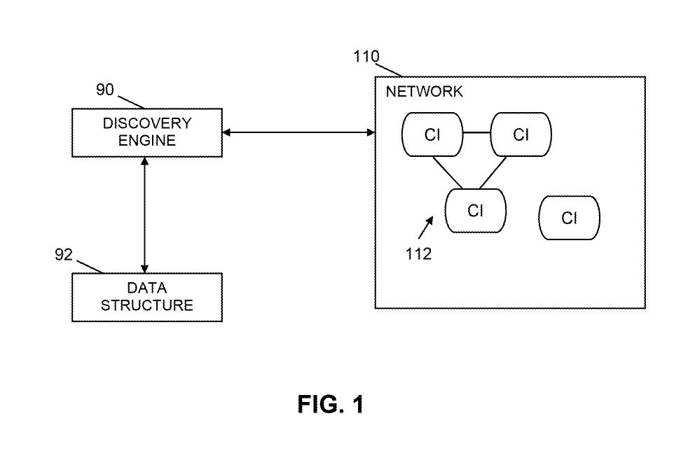

FIG. 1 shows a system in accordance with an example. The system of FIG. 1 shows a discovery engine 90, a data structure 92, and a network 110. The network 110 includes various configuration items (Cls) 112. Some configuration items may be coupled together as shown in the example of FIG. 1, while other configuration items may be standalone. Each configuration item 112 represents an item of hardware and/or software that is configurable. Examples of configuration items include servers, switches, routers, storage devices, processor, operating systems, etc. Any software and/or hardware item in a network that is configurable in some way may be considered to be a configuration item.

The discovery engine 90 performs a discovery process on the network 110 of configuration items 112. The discovery process includes determining which configuration items 112 are present in the network 110 and storing information in the database 92 regarding the discovered configuration items. In some implementations, the discovery engine 90 may broadcast messages (e.g., requests for identification) and wait for responses. Based on the responses, the discovery engine 90 is able to discern what configuration items are present and basic information about each such configuration item such as its name, address, type, etc. The information stored in the data structure 92 includes, among other things, one or more metrics that are to be assessed during run-time of the network 110 for each configuration. The metrics—how they are determined and how they are used—are described below.

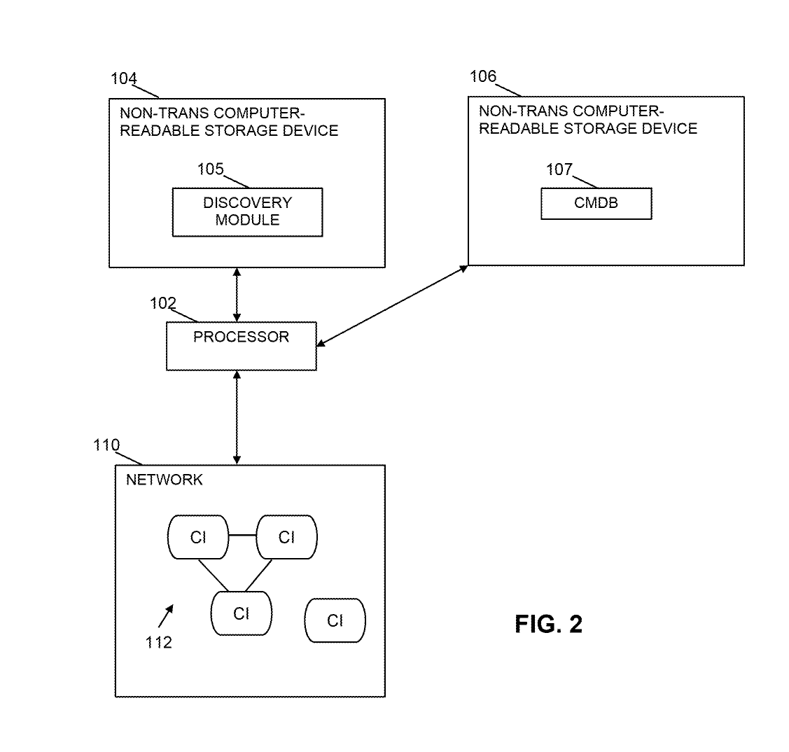

FIG. 2 shows an illustrative implementation of the system of FIG. 1. The system of FIG. 2 shows a processor 102 coupled to non-transitory computer-readable storage devices 104 and 106, as well as the network 110. In some examples, the storage devices 104 and 106 are separate storage devices, while in other devices the storage devices 104, 106 are implemented as one storage device. The storage devices 104, 106 may include volatile storage (e.g., random access memory), non-volatile storage (e.g., hard disk drive, Flash storage, optical disc, etc.) or combinations of volatile and non-volatile storage. Each storage device 104, 106 may be implemented as a single storage device or as multiple storage devices, with the contents distributed across multiple such storage devices.

The storage device 106 as shown includes the data structure 92 from FIG. 1, which in FIG. 2 is shown as a configuration management database (CMDB) 107. Thus, CMDB 107 is an example of data structure 92. CMDB 107 is accessible to the processor 102. The processor 102 is configured to read from or write to the CMDB 107. The storage device 104 includes a discovery module 105 which may comprise software executable by processor 102. As such, the processor 102 combined with the discovery module 105 comprises an example of an implementation of the discovery engine 90. The discovery module 105 causes the processor 102 to perform a discovery process on the network 110 of configuration items 112 as explained above with regard to the discovery engine 90.

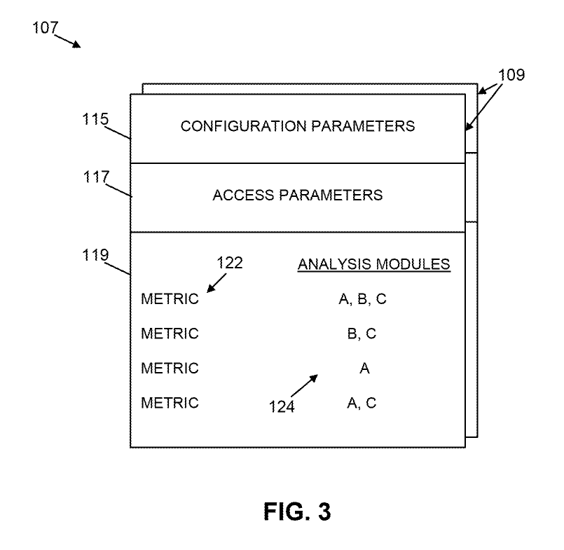

FIG. 3 shows an example of the CMDB 107. In the example of FIG. 3, for each configuration item the data structure stores a record 109 that may contain the following pieces of information: configuration parameters 115, access parameters 117, and metric information 119. Different or additional pieces of information may be included as well. The configuration parameters include a list of the specific parameters that are configurable for the particular configuration item. For example, in the case of a processor, the configuration parameters may include clock speed. In the case of a redundant array of independent discs (RAID) storage subsystem, the configuration parameters may include type of RAID (e.g., RAID 1, RAID 2, etc.). The access parameters 117 include information indicative of how to access each configuration item 112. Such access parameters may include an address (e.g., an Internet Protocol (IP) address), instance name of a database server, etc.

The metric information 119 includes one or more metric identifications 122 that identify individual metrics. The metrics identified by the metric identifications 122 include any type of value or parameter that may be measured, computed, or calculated for a given configuration item. An example of a metric for a processor may be processor utilization. An example of a metric for a storage subsystem may be the amount of used storage and/or the amount of available storage. Associated with each metric identification 122 is an identification 124 of one or more analysis modules, discuss below.

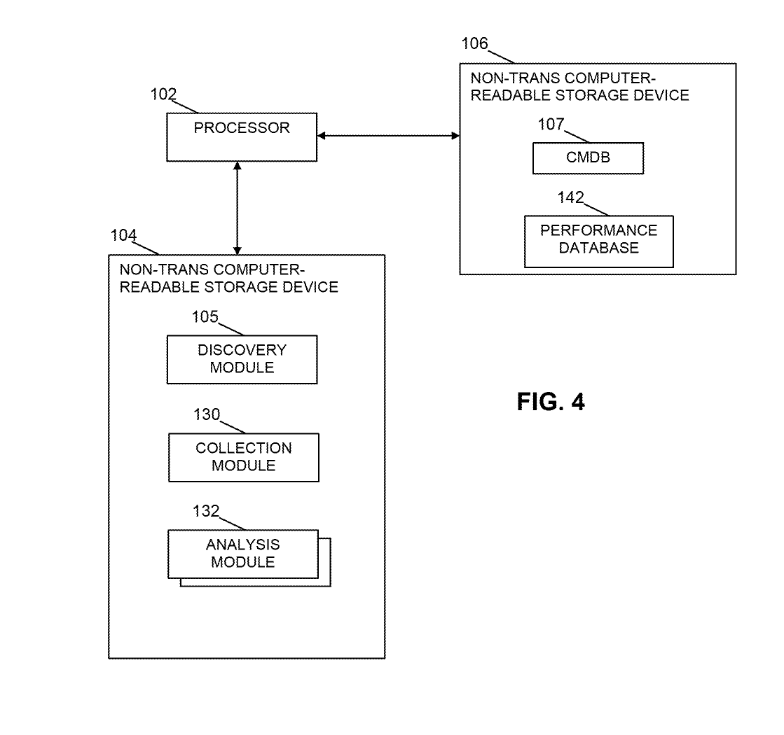

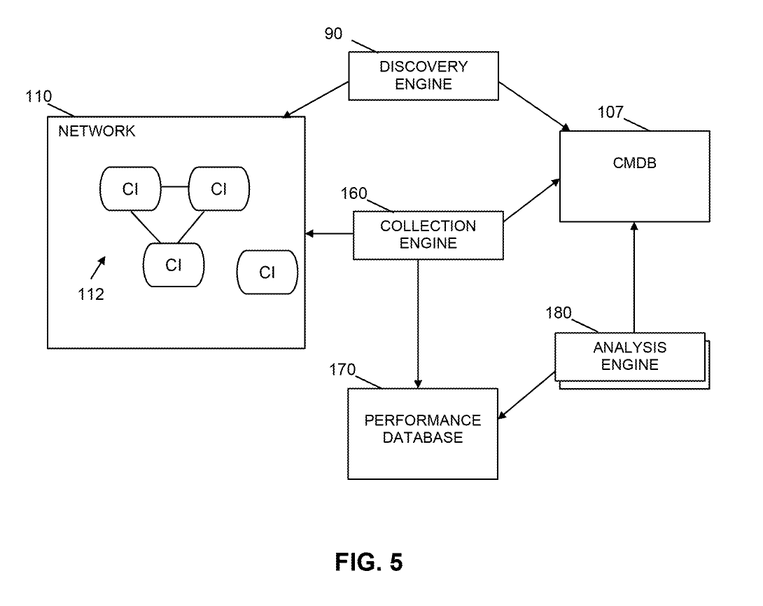

FIGS. 4 and 5 illustrate additional examples. Storage device 106 includes both the CMDB as well as a performance database 142. In addition to the discovery module 105, storage device 105 includes a collection module 130 and one or more analysis modules 132 whose identities 124 may be included in the CMDB 107 and associated with individual metrics (FIG. 3). As with the discovery module 105, the collection module 130 and analysis modules 132 may be embodied as software that is executable by processor 102.

FIG. 5 depicts an example of an architectural overview which shows the discovery engine 90, a collection engine 160 and one or more analysis engines 180 in relation to a network 110 of configuration items 112. The various engines 90, 160, and 180 shown in FIG. 5 may be implemented as a processor (e.g., processor 102) executing a corresponding module (i.e., the discovery module 105, the collection module 130, and the analysis modules 132 of FIG. 4, respectively). The discovery engine 90 may receive identities of metrics that are to be monitored for each type of configuration item. A configuration item type may be a processor, a server, an operating system, etc. The content (e.g., the metrics) for the discovery engine 90 may be configurable. In some implementations, the discovery engine 90 provides a user interface through a user can specify which metrics that the user desires to have monitored for each type of configuration item. The user, for example, can access the user interface for the discovery logic to specify a different set of metrics for different types of configuration items. In other embodiments, the association of metrics to configuration item types may be specified by way of an input file to the discovery engine 90.

The discovery engine 90 performs the discovery process of the network 110 as explained above. Upon encountering a configuration item 112, the discovery engine 90 populates an entry in the CMDB 107. An example of such an entry is shown in FIG. 3. The CMDB entry includes information for the discovered configuration item 112. Such information may include configuration parameters 115, access parameters 117, and the metric(s) specified previously as relevant to that particular type of configuration item. For example, if the discovery engine 90 encounters a server as a configuration item, the discovery logic populates the CMDB 107 with, for example, the configuration parameter(s) for the server, the access parameters for the server, and the metric(s) specified to the discovery tool to be monitored for a configuration item of type “server.” The discovery engine 90 may be pre-configured with such information for each type of configuration item. Thus, during the discovery process, the CMDB 107 is created, and the discovery engine 90 stores and associates an identification of a metric for each configuration item listed in the CMDB 107. Alternately, the discovery engine 90 may create the CMDB 107 at the end of the discovery process based on the configuration items encountered during the discovery process. The discovery process may be performed upon system initialization, or upon a user manually forcing a new round of discovery to occur.

During run-time of the network 110, the collection engine 160 collects the various metrics 119 specified in the CMDB 107 for each configuration item 112. The collection engine 160 reads the CMDB 107 to determine which configuration items are present in the network, the access parameters for 117 for each such configuration item, and the metrics 119 to be obtained for each such configuration item. The collection engine 160 thus accesses the CMDB 107 to determine for which metrics to collect performance data for each configuration item. As noted above, any given metric 119 may be measured, estimated, or calculated by the collection engine 160. The collection engine 160 then stores the metric data (i.e., the data values being measured, estimated or calculated) in the performance database 170. The performance database 142 thus contains metric data for each of various configuration items being monitored during run-time.

During or after run-time, a user may choose to use an analysis engine 180 to analyze an aspect of the network. An example of an analysis engine 180 includes a graphing tool which may be configured to, for example, plot processor utilization versus time. Another example of an analysis engine 180 includes a forecasting tool which uses CPU utilization to forecast future CPU utilization, a reactive tool which is used to check on the breach of threshold values for metrics (e.g., disk space utilized), or a resource optimization tool that uses the CPU run queue to plan for optimal resource utilization.

Each analysis engine 180 receives as an input metric data from the performance database 170 for a particular configuration item of interest to that particular analysis engine 180. The analysis tool consults the CMDB 107 for the configuration item(s) that pertain to that tool. For example, if a graphing tool plots processor utilization, then that tool reads the CMDB 107 to determine which metrics 122 are available for the processors. The analysis engine(s) 180 then access the performance database 170 to retrieve the metric data of interest and use the retrieved metric data in accordance with the functionality of the analysis tool. The discovery engine 90 identifies and stores the association of metrics to configuration items and also the association of metrics to various analysis tools in the CMDB 107.

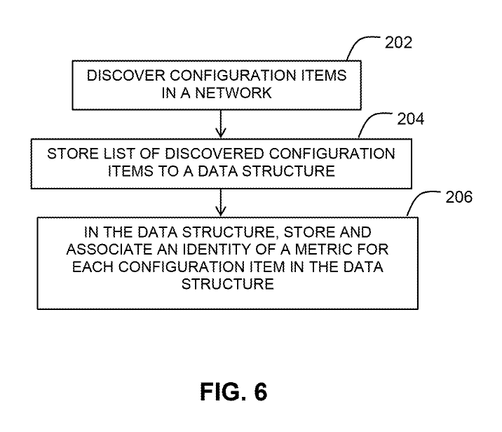

FIG. 6 shows a method in accordance with an example. The actions depicted in FIG. 6 may be performed in the order shown, or in a different order, and two or more of the actions may be performed in parallel, rather than serially. The actions depicted in FIG. 6 may be performed by the discovery engine 90.

At 202, the method includes discovering configuration items 112 in a network. At 204, the method includes storing a list of discovered configuration items to a data structure 92 (e.g., the CMDB 107). At 206, the method includes, in the data structure, storing and associating an identity of a metric for each configuration item that is provided in the database. One or more analysis tools may also be included in the association in 206.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a discovery engine to perform a discovery process on a network of multiple configuration items and to populate a data structure with information about each discovered configuration item in the network; and
wherein the information includes a configuration parameter for each configuration item and a metric to be monitored for the configuration item.

2. The system of claim 1 wherein said information included in the data structure for at least one configuration item is to include identifications of a plurality of metrics for that configuration item.

3. The system of claim 1 wherein for each metric for a given configuration item, the information in the data structure is to identify an analysis engine for which the metric is to be used.

4. The system of claim 3 wherein, for a configuration item in the data structure having a plurality of metrics with an analysis engine associated with each metric, at least one analysis engine associated with a particular metric being different than an analysis engine associated with another metric.

5. The system of claim 1 wherein content of the discovery engine is configurable.

6. The system of claim 1 wherein the discovery engine is to provide a user interface by which a user specifies the metrics for each type of configuration item in the network.

7. The system of claim 6 wherein the user interface is to permit a user to specific a different set of metrics for different types of configuration items.

8. The system of claim 1 further comprising a collection engine to access the data structure to determine for which metrics to collect performance data for each configuration item.

9. The system of claim 1 further comprising an analysis engine to access the data structure to determine the metrics that are available for a configuration item.

10. The system of claim 1 wherein the data structure is to include a plurality of metrics for each configuration item and, for each configuration item, the data structure identifies which of a plurality of analysis engines are applicable to a particular metric, and each analysis engine is to access the data structure to determine the metrics that are applicable to that analysis engine for each configuration item.

11. A non-transitory, computer-readable storage device storing software that, when executed by a processor, causes the processor to:
discover configuration items in a network;
store a list of discovered configuration items to a data structure; and
in the data structure, store and associate an identity of a metric for each configuration item listed in the data structure.

12. The non-transitory, computer-readable storage device of claim 11 wherein for each metric associated with a given configuration item, the software causes the processor to store and associate in the data structure an identity of an analysis tool for which the metric is to be used.

13. The non-transitory, computer-readable storage device of claim 12 wherein, for a configuration item associated with a plurality of metrics in the data structure, at least one analysis tool associated with a particular metric being different than an analysis tool associated with at least one other metric.

14. The non-transitory, computer-readable storage device of claim 11 wherein the software causes the processor to permit a user to configure which metrics are to be associated with each type of configuration item during said discovery.

15. The non-transitory, computer-readable storage device of claim 11 wherein said software causes the processor to associate identities of different metrics with different configuration items.

16. The non-transitory, computer-readable storage device of claim 11 wherein the data structure includes a plurality of metrics for each configuration item and, for each configuration item, the data structure identifies which of a plurality of analysis tools are applicable to a particular metric, and wherein the software causes the processor to implement a plurality of analysis tools, and each analysis tool accesses the data structure to determine the metrics that are applicable to that analysis tool for each configuration item.

17. A method, comprising:
discovering configuration items in a network;
storing a list of discovered configuration items to a data structure; and
in the data structure, storing and associating an identity of a metric for each configuration listed in the data structure.

18. The method of claim 17 wherein for each metric associated with a given configuration item, the software causes the computer to store and associate in the data structure an identity of an analysis tool for which the metric is to be used.

19. The method of claim 18 wherein storing and associating an identity of a metric includes storing and associating a plurality of identities of metrics in the data structure for at least one configuration item, and wherein the method further comprises storing and associating an analysis tool with each metric of a configuration item associated with multiple metrics, and wherein an analysis tool associated with one metric is different than an analysis tool associated with another metric.

20. The method of claim 17 further comprising implementing a user interface by which a user can configure which metrics are to be associated with each type of configuration item during said discovery.
